(19) United States
(12) Patent Application Publication
(10) Pub. No.: US 2007/0069994 A1
(43) Pub. Date: Mar. 29, 2007

(54) Circuit for driving load with constant current

(75) Inventor: Mitsuasa Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD Technologies, Ltd.

(21) Appl. No.: 11/525,082

(22) Filed: Sep. 22, 2006

(30) Foreign Application Priority Data
Sep. 26, 2005 (JP) 2005-277914

(51) Int. Cl. G09G 3/30

(52) U.S. Cl. 345/76

(57) ABSTRACT

A circuit for driving a load with a constant current, includes a first transistor electrically connected in series to a load to be driven, a second transistor electrically connected in series to the load, and electrically connected in parallel with the first transistor, and a resistor electrically connected in series to the second transistor.

### BACKGROUND OF THE INVENTION

1. Field of the Invention

The invention relates to a circuit for driving a load with a constant current.

2. Description of the Related Art

With recent development in technologies, there has been suggested a display unit including a light-emitting device such as an active matrix type organic electro-luminescence (EL) device or an organic light-emitting diode (OLED).

Since there is correlation between an intensity of light emitted from an organic EL device and a current running through an organic EL device, it is necessary to drive an organic EL device with a constant current in order to control a brightness.

An example of a circuit for driving an active matrix type organic EL device with a constant current is found in Japanese Patent Application Publication No. 2002-91377.

FIG. 1 is a circuit diagram of a circuit 1000 for driving an active matrix type organic EL device with a constant current, suggested in the above-mentioned Publication.

As illustrated in FIG. 1, the circuit 1000 is comprised of a first input terminal 1001 through which a current is input into the circuit 1000 from a power source (not illustrated), an organic electro-luminescence (EL) device 1002, a power-source control circuit 1003 comprised of a first field effect transistor (FET) 1004, a current-detecting circuit 1005 comprised of a first resistor 1006, a differentially amplifying circuit 1007, a sample-holding circuit 1012, a second input terminal 1015 through which a sample-holding pulse is input into the circuit 1000, and a third input terminal 1016 through which a voltage is input into the circuit 1000.

The differentially amplifying circuit 1007 is comprised of a second field effect transistor 1008, a third field effect transistor 1009, a second resistor 1010, and a third resistor 1011.

The sample-holding circuit 1012 is comprised of a fourth field effect transistor 1013, and a capacitor 1014.

The first input terminal 1001 is electrically connected to an anode terminal of the organic electro-luminescence (EL) device 1002.

A cathode terminal of the organic electro-luminescence (EL) device 1002 is electrically connected to a drain terminal of the first field effect transistor 1004.

The first resistor 1006 is electrically connected at one end thereof to a source terminal of the first field effect transistor 1004, and is grounded at the other end.

The third field effect transistor 1009 has a gate terminal electrically connected to a first node 1020 through which the first resistor 1006 and the first field effect transistor 1004 are electrically connected to each other. Hence, a voltage drop caused in the current-detecting circuit 1005 is input into the gate terminal of the third field effect transistor 1009.

The second resistor 1010 is electrically connected across a drain terminal of the third field effect transistor 1009 and the first input terminal 1001. A second node 1021 through which a drain terminal of the third field effect transistor 1009 and the second resistor 1010 are electrically connected to each other is electrically connected to a gate terminal of the first field effect transistor 1004.

The second field effect transistor 1008 has a drain terminal electrically connected to a third node 1022 through which the second resistor 1010 and the first input terminal 1001 are electrically connected to each other.

The third resistor 1011 is electrically connected at one end thereof to source terminals of the second and third field effect transistors 1008 and 1009, and is grounded at the other end.

A gate terminal of the second field effect transistor 1008, the capacitor 1014 and a source terminal of the fourth field effect transistor 1013 are electrically connected to one another at a fourth node 1023.

The capacitor 1014 is electrically connected at one end thereof to the fourth node 1023, and is grounded at the other end.

The fourth field effect transistor 1013 has a source terminal electrically connected to the fourth node 1023, a drain terminal electrically connected to the third input terminal 1016, and a gate terminal electrically connected to the second input terminal 1015.

A voltage corresponding to a voltage drop to be caused in the current-detecting circuit 1005 by a current running through the organic EL device 1002 is input into the circuit 1000 through the third input terminal 1016.

A voltage input into a drain terminal of the fourth field effect transistor 1013 through the third input terminal is held in the capacitor 1014, when, on receipt of a sample-holding pulse through the second input terminal 1015, the fourth field effect transistor 1013 is turned on.

The thus held voltage, that is, a voltage at the third input terminal 1016, is input into a gate terminal of the second field effect transistor 1008.

When a voltage drop detected by the current-detecting circuit 1005 is smaller than the voltage input through the third input terminal 1016, the third field effect transistor 1009 is turned off, and a gate voltage of the power-source control circuit 1003 turns to a high level. As a result, the first and fourth field effect transistors 1004 and 1013 make attempt to cause a voltage of the current-detecting circuit 1005 and a voltage of the third input terminal 1016 to be close to each other by allowing a current to run much therethrough.

On the other hand, when a voltage drop detected by the current-detecting circuit 1005 is higher than the voltage input through the third input terminal 1016, the third field effect transistor 1009 is turned on, and a drain voltage of the third field effect transistor 1009 turns to a low level. As a result, the power-source control circuit 1003 is turned off, and drives the organic EL device 1002 with a constant current for reducing a current such that a voltage of the current-detecting circuit 1005 and a voltage of the third input terminal 1016 are equal to each other.

However, the conventional circuit 1000 illustrated in FIG. 1 is accompanied with a problem that much current is consumed, because the conventional circuit 1000 makes use of a voltage drop in the current-detecting circuit 1005 electrically connected in series to the organic EL device 1002.

Japanese Patent Application Publication No. 2001-345686 has suggested a circuit for detecting a current, including an input terminal through which a current enters the circuit, an output terminal through which the current leaves the circuit, a current-detecting switching device having a first electrode electrically connected to the input terminal, a second electrode, and a control electrode controlling a current running across the first and second electrodes, a main switching device having a first electrode electrically connected to the input terminal, a second electrode electrically connected to the output terminal, and a control electrode controlling a current running across the first and second electrodes, a resistor electrically connected between the second electrode of the current-detecting switching device and the output terminal, means for generating a reference voltage, based on a voltage of the input terminal, and means for comparing a sensing voltage of the second electrode of the current-detecting switching device to the reference voltage.

Japanese Patent Application Publication No. 2003-43994 has suggested an active matrix type display unit including current-voltage converters electrically connected in series to each other in a path through which a drive current is supplied to a light-emitting device, and a current source driven by a voltage output from the current-voltage converters. When a drive current is defined, a monitoring current having correlation with the drive current is generated. A gate voltage of a transistor which generates a drive current is controlled based on the monitoring current to accomplish desired brightness. The thus controlled gate voltage is held in a capacitor.

Japanese Patent Application Publication No. 2003-195815 has suggested an active matrix type display unit including (a) a display device having a plurality of pixel circuits arranged in a matrix, a plurality of scanning lines for selecting a pixel circuit, and a plurality of data lines each providing image data to each of the pixel circuits, and (b) a drive circuit which provides the image data in the form of a current to each of the data lines to thereby write the image data into each of the pixel circuits.

Japanese Patent Application Publication No. 10-256541 has suggested a circuit for driving a load, including a current-supplying MOS transistor for supplying a current to a load, a current-detecting MOS transistor electrically connected in parallel with the current-supplying MOS transistor and defining a current mirror circuit together with the current-supplying MOS transistor, and a resistor electrically connected to the current-detecting MOS transistor. Each of the current-supplying MOS transistor and the current-detecting MOS transistor is comprised of a horizontal MOS transistor defining a current path horizontally extending on a surface of a semiconductor substrate. A ratio between a current running through the current-supplying MOS transistor and a current running through the current-detecting MOS transistor is defined as a ratio between a sum of an ON-resistance of the current-supplying MOS transistor and a resistance of wirings of source and drain of the current-supplying MOS transistor, and a sum of an ON-resistance of the current-detecting MOS transistor, a resistance of wirings of source and drain of the current-detecting MOS transistor, and a resistance of the resistor.

Japanese Patent Application Publication No. 10-271659 has suggested a circuit for detecting an excess current including (a) a main MOSFET having a drain terminal electrically connected to a load, and a grounded source terminal, (b) a mirror MOSFET having a gate terminal electrically connected to a gate terminal of the main MOSFET, and a drain terminal electrically connected to a drain terminal of the main MOSFET, said mirror MOSFET having a 1/N size relative to a size of the main MOSFET and allowing a 1/N current to run therethrough relative to a current running through the main MOSFET, (c) a resistor electrically connected across a source terminal of the mirror MOSFET and a ground, (d) a comparator having a first input terminal electrically connected to a source terminal of the mirror MOSFET, and a second input terminal electrically connected to an output of a reference voltage source, and (e) a control circuit carrying out on/off control to the main MOSFET in accordance with an external signal for driving the main MOSFET and an output signal transmitted from the comparator. A pad through which a voltage is externally provided is arranged at a source terminal of the mirror MOSFET, an output terminal of the reference voltage source, electrically connected to an input terminal of the comparator, and an output terminal of the comparator.

Japanese Patent Application Publication No. 2004-233620 has suggested a drive circuit including an output terminal to which a light- or electron-emitter is connected, and a compensation circuit for compensating for a voltage output from the output terminal. The compensation circuit includes a drive transistor having a pair of main electrodes each electrically connected t the output terminal and a reference voltage source, an amplifier for controlling a voltage output from the drive transistor, a current-detecting transistor for detecting a current running through the drive transistor, a first feedback loop detecting a voltage output through the output terminal, and feeding the detected voltage back to the amplifier, and a second feedback loop detecting a current output from the current-detecting transistor, and feeding the detected current back to the amplifier. The drive and current-detecting transistors cooperate with each other to define a mirror circuit.

Japanese Patent Application Publication No. 2005-55373 has suggested a current-detecting circuit in which an output transistor and a sensing transistor having the same electrical conductivity as that of the output transistor are made identical with each other with respect to an operation condition, and a current running through the sensing transistor is detected.

Japanese Patent Application Publication No. 2005-505802 has suggested a circuit for driving a light-emitting device with a predetermined current, including a current mirror circuit comprised of a first transistor and a second transistor, characterized by a reference current source, a first switching device which electrically connects the first transistor to the light-emitting device or the reference current source, a second switching device which electrically connects the second transistor to the light-emitting device or the reference current source, and a controller which operates the first and second switching devices in synchronization with each other.

### SUMMARY OF THE INVENTION

In view of the above-mentioned problems in the conventional circuit, it is an object of the present invention to provide a circuit for driving a load with a constant current, which can operate in smaller power consumption than a conventional circuit for doing the same.

In one aspect of the present invention, there is provided a circuit for driving a load with a constant current, including a first transistor electrically connected in series to a load to be driven, a second transistor electrically connected in series to the load, and electrically connected in parallel with the first transistor, and a resistor electrically connected in series to the second transistor.

The circuit may further include a control circuit which compares a voltage drop caused by the resistor to a reference voltage, and controls the first transistor such that the voltage drop is equal to the reference voltage.

For instance, the control circuit is comprised of a comparator.

It is preferable that the reference voltage is equal to a voltage for causing a predetermined current to run through the first transistor.

For instance, the load is comprised of an organic light emitting diode.

For instance, the load is comprised of an inorganic light emitting diode.

It is preferable that a maximum current running through the second transistor is smaller than a maximum current running through the first transistor.

There is further provided a circuit for driving a load with a constant current, including a load to be driven, a first transistor, a second transistor, a resistor, and a comparator, wherein the load is electrically connected at one end thereof to a power source, and at the other end to drains of the first and second transistors, the first transistor has a gate receiving an output from the comparator, a drain electrically connected to the load, and a grounded source, the second transistor has a gate receiving an output from the comparator, a drain electrically connected to the load, and a source electrically connected to a node, the resistor is electrically connected at one end thereof to the node, and is grounded at the other end, and the comparator has a negative input terminal electrically connected to the node and a positive input terminal through which the comparator receives a reference voltage.

The advantages obtained by the aforementioned present invention will | be described hereinbelow.

In accordance with the present invention, it is possible to reduce power consumption in a circuit for driving a load with a constant current. In other words, the circuit for driving a load with a constant current in accordance with the present invention can operate with smaller power consumption than the conventional circuit for doing the same.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a circuit diagram of a conventional circuit for driving a load with a constant current.

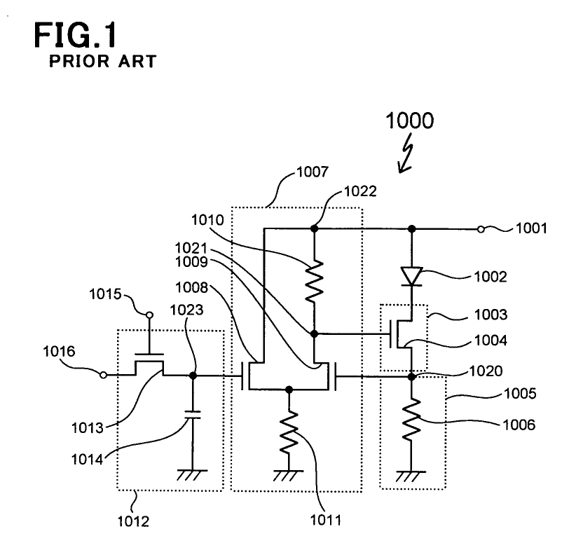

FIG. 2 is a circuit diagram of a circuit for driving a load with a constant current in accordance with a preferred embodiment of the present invention.

### DESCRIPTION OF THE PREFERRED EMBODIMENT

A preferred embodiment in accordance with the present invention will be explained hereinbelow with reference to drawings.

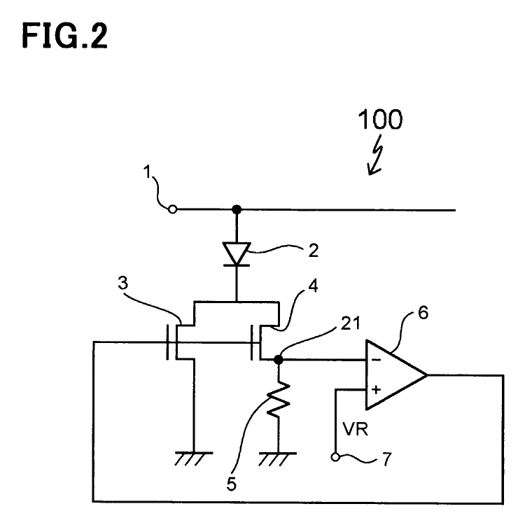

FIG. 2 is a circuit diagram of a circuit 100 for driving a load with a constant current in accordance with a preferred embodiment of the present invention.

As illustrated in FIG. 2, the circuit 100 is comprised of a first input terminal 1, an organic light-emitting diode (OLED) 2 as a load to be driven, a first thin film transistor 3, a second thin film transistor 4, a resistor 5, a comparator 6, and a second input terminal 7.

A current is input into the circuit 100 from a power source (not illustrated) through the first input terminal 1.

The organic light-emitting diode 2 is electrically connected through an anode terminal thereof to the first input terminal 1, and to drains of the first and second thin film transistors 3 and 4 through a cathode terminal thereof.

The first thin film transistor 3 has a gate receiving an output from the comparator 6, a drain electrically connected to a cathode terminal of the organic light-emitting diode 2, and a grounded source.

The second thin film transistor 4 has a gate receiving an output from the comparator 6, a drain electrically connected to a cathode terminal of the organic light-emitting diode 2, and a source electrically connected to a node 21.

The first and second thin film transistors 3 and 4 are electrically connected in parallel to the organic light-emitting diode 2.

The resistor 5 is electrically connected at one end thereof to the node 21, and is grounded at the other end.

The comparator 6 has a negative (inversion) input terminal electrically connected to the node 21 and a positive (normal) input terminal electrically connected to the second input terminal 7.

The comparator 6 receives a reference voltage VR through a positive input terminal thereof.

The second thin film transistor 4 is used for sensing a current running through the circuit 100. Thus, the second thin film transistor 4 has smaller current capacity than the first thin film transistor 3. Specifically, a maximum current running through the second thin film transistor 4 is smaller than a maximum current running through the first thin film transistor 3.

A relation between a voltage drop caused by the resistor 5 and a current running through the first thin film transistor 3 is measured in advance by TEG (Test Experimental Group or Test Element Group), for instance. The measured relation is stored in a memory (not illustrated). The reference voltage VR is defined in accordance with the measured relation. As mentioned above, the reference voltage VR is input into the comparator 6 through a positive input terminal of the comparator 6 through the second input terminal 7.

The voltage drop caused in the resistor 5 is input into the comparator 6 through a negative input terminal thereof.

The comparator compares the voltage drop caused in the resistor 5 to the reference voltage VR received through a positive input terminal thereof, and outputs the result of comparison to gate terminals of the first and second thin film transistors 3 and 4. The reference voltage VR corresponds to a voltage to be applied to the first thin film transistor 3.

The comparator 6 controls the first and second thin film transistors 3 and 4 such that the voltage drop caused in the resistor 5 is equal to the reference voltage VR. Thus, the organic light-emitting diode 2 is driven with a constant current.

As having been explained so far, in the circuit 100 in accordance with the embodiment of the present invention, the first thin film transistor 3 for mainly driving the organic light-emitting diode 2 and the second thin film transistor 4 mainly used for sensing a current running through the circuit 100 are electrically connected in parallel to each other, and the comparator 6 compares the voltage drop caused by a current running through the resistor 5 electrically connected to the second thin film transistor 4, to the reference voltage VR which corresponds to the voltage drop caused in the resistor 5 and which is necessary to allow a desired current to run through the first thin film transistor 3. The gate voltages of the first and second thin film transistors 3 and 4 are controlled by a fed-back output transmitted from the comparator 6, thereby the organic light-emitting diode 2 is driven with a constant current.

The circuit 100 in accordance with the embodiment makes it possible to reduce power consumption necessary for detecting a current in inverse proportion to a square of a ratio between a current running through the resistor 5 and the rest of a current running in the circuit 100, because a current running through the first thin film transistor 3 as a main transistor for driving the organic light-emitting diode 2 is detected by means of both the second thin film transistor 4 electrically connected in parallel with the first thin film transistor 3, and having smaller current capacity than the first thin film transistor 3, and the resistor 5 electrically connected to a source terminal of the second thin film transistor 4.

Furthermore, the power consumption can be further reduced by increasing a resistance of the resistor 5, because the voltage drop caused in the resistor 5 is in almost proportion to a current running through the first thin film transistor 3, even if the resistance 5 had a high resistance.

The circuit 100 in accordance with the embodiment may be used in an active matrix type organic electro-luminescence (EL) display device, for instance.

In the above-mentioned embodiment, a load to be driven by the circuit 100 is comprised of the organic light-emitting diode 2. However, an inorganic light-emitting diode may be driven in place of the organic light-emitting diode 2. As an alternative, a load other than a light-emitting diode may be driven in the circuit 100 in accordance with the embodiment.

In the above-mentioned embodiment, the circuit 100 includes a low-side switch comprised of an n-channel thin film transistor. In place of an n-channel thin film transistor, the circuit 100 may be designed to include a high-side switch comprised of a p-channel thin film transistor.

In the above-mentioned embodiment, a power source (not illustrated) supplies a fixed voltage to the circuit 100 through the first input terminal 1. In place of using a power source, there may be used scanning lines to apply a desired voltage to the circuit 100.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2005-277914 filed on Sep. 26, 2005 including specification, claims, drawings and summary is incorporated herein by reference in its entirety.

What is claimed is:

1. A circuit for driving a load with a constant current, comprising:
a first transistor electrically connected in series to a load to be driven;
a second transistor electrically connected in series to said load, and electrically connected in parallel with said first transistor; and
a resistor electrically connected in series to said second transistor.

2. The circuit as set forth in claim 2, further comprising a control circuit which compares a voltage drop caused by said resistor to a reference voltage, and controls said first transistor such that said voltage drop is equal to said reference voltage.

3. The circuit as set forth in claim 2, wherein said control circuit is comprised of a comparator.

4. The circuit as set forth in claim 2, wherein said reference voltage is equal to a voltage for causing a predetermined current to run through said first transistor.

5. The circuit as set forth in claim 1, wherein said load is comprised of an organic light emitting diode.

6. The circuit as set forth in claim 1, wherein said load is comprised of an inorganic light emitting diode.

7. The circuit as set forth in claim 1, wherein a maximum current running through said second transistor is smaller than a maximum current running through said first transistor.

8. A circuit for driving a load with a constant current, comprising:
a load to be driven;
a first transistor;
a second transistor;
a resistor; and
a comparator,
wherein said load is electrically connected at one end thereof to a power source, and at the other end to drains of said first and second transistors,
said first transistor has a gate receiving an output from said comparator, a drain electrically connected to said load, and a grounded source,
said second transistor has a gate receiving an output from said comparator, a drain electrically connected to said load, and a source electrically connected to a node,
said resistor is electrically connected at one end thereof to said node, and is grounded at the other end, and
said comparator has a negative input terminal electrically connected to said node and a positive input terminal through which said comparator receives a reference voltage.

9. The circuit as set forth in claim 8, wherein said comparator compares a voltage drop caused by said resistor to said reference voltage, and controls said first transistor such that said voltage drop is equal to said reference voltage.

10. The circuit as set forth in claim 8, wherein said reference voltage is equal to a voltage for causing a predetermined current to run through said first transistor.

11. The circuit as set forth in claim 8, wherein said load is comprised of an organic light emitting diode.

12. The circuit as set forth in claim 8, wherein said load is comprised of an inorganic light emitting diode.

13. The circuit as set forth in claim 8, wherein a maximum current running through said second transistor is smaller than a maximum current running through said first transistor.
